(19) United States
(12) Patent Application Publication
(10) Pub. No.: US 2016/0125976 A1
(43) Pub. Date: May 5, 2016

(54) CONDUCTIVE WIRE WITH SEAL FUNCTION AND MANUFACTURING METHOD THEREOF

(71) Applicant: Sumitomo Wiring Systems, Ltd., Yokkaichi (JP)

(72) Inventor: Takamasa MAEDA, Yokkaichi (JP)

(21) Appl. No.: 14/883,008

(22) Filed: Oct. 14, 2015

(30) Foreign Application Priority Data
Nov. 4, 2014 (JP) 2014224197

(51) Int. Cl. H01B 7/00; H01B 13/02

(52) U.S. Cl. CPC H01B 7/0009; H01B 13/02; H01B 13/0292

(57) ABSTRACT

A conductive wire includes a core formed of a plurality of conductive metal strands, a coating portion formed of an insulating material and configured to cover the core and seal portions arranged at intermediate positions in a coating portion and configured to hold clearances between the strands and between the core and the coating portion in a water-tight state. A sealant is supplied before the respective strands are twisted. By doing so, the sealant can be spread to a central part of the core and the clearances between the strands can be filled with the sealant.

This application claims the benefit of Japanese Application No. JP2014-224197, filed on Nov. 4, 2014, the contents of which are hereby incorporated by reference in their entirety.

### FIELD

This invention relates to a conductive wire with a seal function and a manufacturing method thereof.

### BACKGROUND

Conventionally, ground terminals have been frequently connected to electrical devices for automotive vehicles via wires and some of them have been arranged in engine compartments or the like of automotive vehicles. Since an engine compartment may be exposed to water, if a wire connected to a wire barrel of a ground terminal is wetted, water easily penetrates into a wire coating through clearances between strands. If water infiltrates into the wire coating, water infiltration may progress by a capillary phenomenon and water may reach an electrical device.

A water stop structure disclosed in Japanese Unexamined Patent Publication No. 2004-72943 is known as an example of a measure for avoiding such a situation. In this water stop structure, a coating of a wire connected to a ground terminal is removed at an intermediate position to expose a core, and strands of an exposed part are welded. By doing so, water infiltrating from a connected part to the ground terminal does not move any further, and the part exposed by removing the coating is wound with a silicon coated tape.

However, in such a water stopping method, many post-processes such as the removal of the coating of the wire at the intermediate position, the welding of the strands and the winding of the silicon tape are necessary to form the water stop structure, which has presented a problem of poor operation efficiency in laying the wire.

The conductive wire presently described with a seal function and a manufacturing method thereof enable an efficient wire laying operation and address the situation mentioned above.

### SUMMARY

A conductive wire with a seal function according to a first aspect includes a core formed of a plurality of conductive metal strands, a coating portion formed of an insulating material and configured to cover the core and a seal portion arranged in the coating portion and configured to hold clearances between the strands and between the core and the coating portion in a water-tight state.

A manufacturing method of a conductive wire with a seal function according to a second aspect includes a strand supplying step of supplying a plurality of conductive metal strands, a twisting step of twisting the metal strands after the stand supplying step, a sealant supplying step of attaching a sealant to the metal strands before or during the twisting step and a coating forming step of covering the twisted metal strands and the seal portion along a longitudinal direction with a coating portion.

According to the first aspect, since the seal portion is arranged in the coating portion, a situation where water infiltrates beyond the seal portion can be reliably avoided even if water infiltrates from an end of the coating portion. Specifically, since the conductive wire itself is provided with the seal function, a special operation for sealing is not necessary at all in a conductive wire laying operation. Thus, the conductive wire laying operation can be efficiently performed.

According to the second aspect, since the seal portion is formed before or while the strands are twisted, an effect of easily spreading the sealant between the strands is obtained.

### DRAWINGS

Preferred exemplary embodiments of the invention will hereinafter be described in conjunction with the appended drawings, wherein like designations denote like elements, and wherein:

FIG. 1 is a plan view of a ground terminal with conductive wire;

FIG. 2 is a side view in section showing a connected part of the ground terminal and a wire;

FIG. 3 is a section along A-A of FIG. 2;

FIG. 4 is a section along B-B of FIG. 2; and

FIG. 5 is a process diagram outlining a manufacturing method of a conductive wire with a seal function.

### DESCRIPTION

Preferred embodiments of the present invention are described herein.

In the conductive wire with the seal function, the seal portion and the coating portion may be formed of the same material.

According to this configuration, since the seal portion and the coating portion are formed of the same material, they are easily bonded and effective in ensuring sealability. Further, since the rigidity of the conductive wire is enhanced at a position where the seal portion is formed, so-called buckling (buckling of the conductive wire) can be made difficult to occur. Further, the seal portion may be formed over an entire length range of the coating portion in the coating portion.

According to this configuration, the seal function in the conductive wire can be further enhanced.

Next, a specific embodiment of a conductive wire with a seal function is described with reference to the drawings.

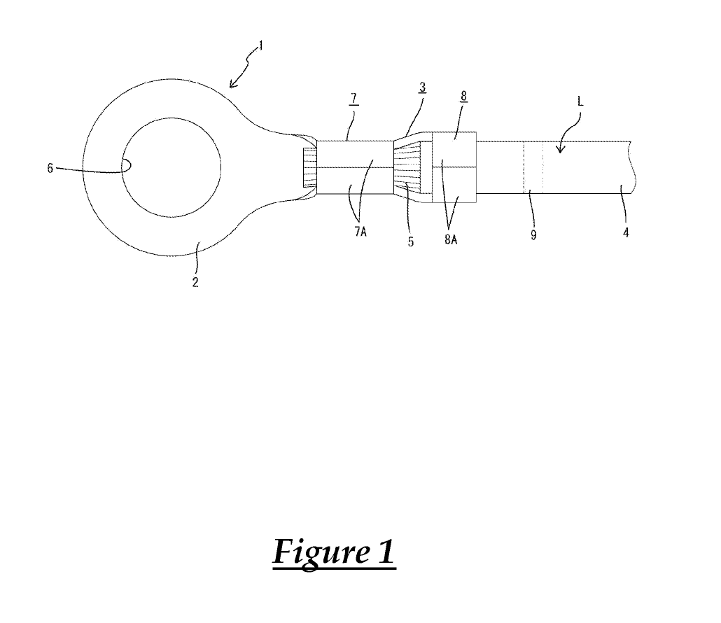

FIG. 1 shows a ground terminal with conductive wire in which a ground terminal 1 is connected to the tip of a conductive wire L of this embodiment. A coating is removed over a predetermined length range on a tip part of the conductive wire L to expose a core 5. The ground terminal 1 is formed of a flat plate material made of conductive metal. The ground terminal 1 is composed of a ground connecting portion 2 connectable to an unillustrated ground point and a wire connecting portion 3 to be connected to the conductive wire L.

The ground connecting portion 2 is formed into a ring shape and a circular bolt hole 6 is open for connection to the ground point by bolting. The wire connecting portion 3 is provided with a wire barrel 7 to be connected to the core 5 of the conductive wire L and an insulation barrel 8 located behind the wire barrel 7 and to be connected to a coating portion 4 of the conductive wire L. Both the wire barrel 7 and the insulation barrel 8 include a pair of barrel pieces 7A, 8A and are connected to the conductive wire L by caulking these barrel pieces 7A, 8A.

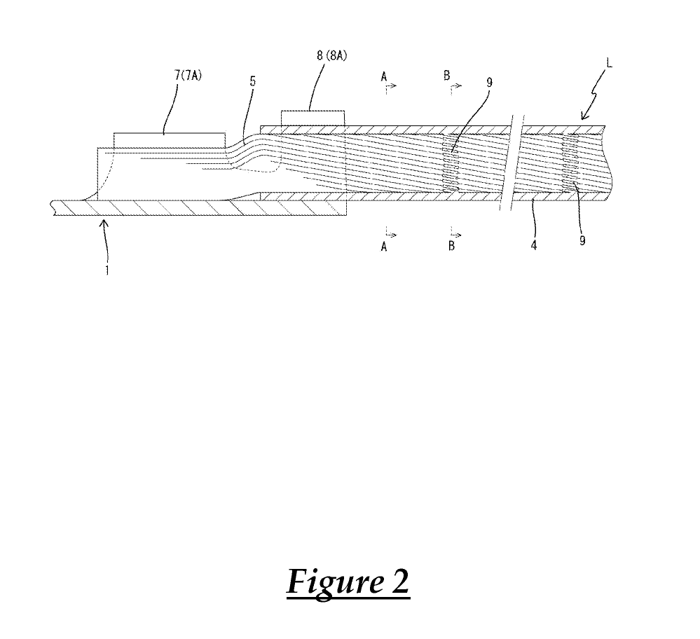

The conductive wire L is configured to include the core 5 and the coating portion 4 covering the core 5. The core 5 is formed by twisting a multitude of conductive metal strands 5A. As shown in FIG. 2, seal portions 9 are provided at a plurality of positions in the coating portion 4. In this embodiment, the seal portions 9 are arranged at constant intervals in a length direction of the conductive wire L. FIG. 2 shows a state where the seal portion 9 closest to an end part is located behind the insulation barrel 8.

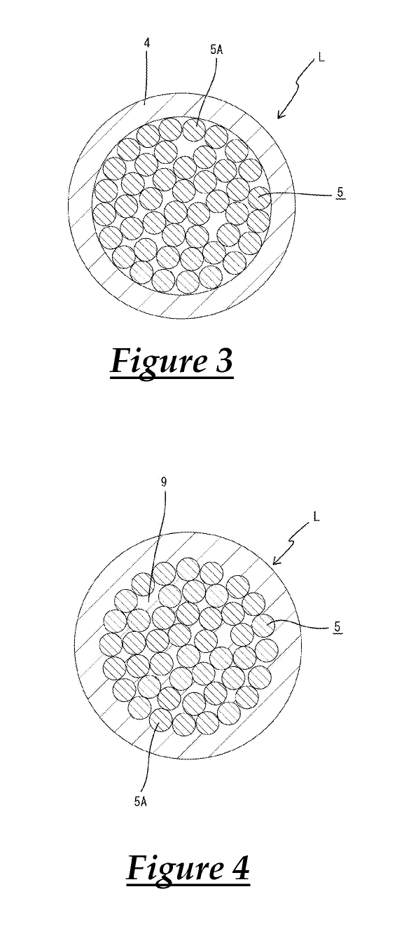

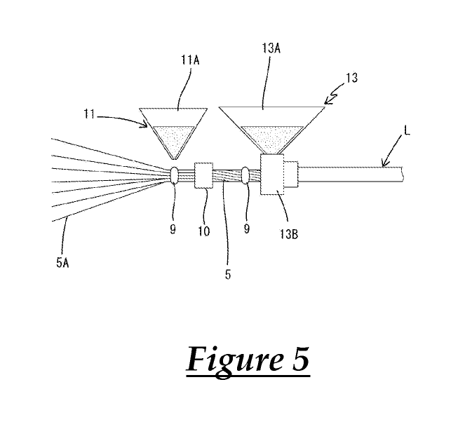

A state of the conductive wire L in a cross-section at a position where the seal portion 9 is not formed is as shown in FIG. 3. Specifically, as shown in FIG. 3, there are small clearances between the strands 5A and between the strands 5A and the inner peripheral surface of the coating portion 4. Contrary to this, a state of the conductive wire L in a cross-section at a position where the seal portion 9 is formed is as shown in FIG. 4.

The seal portion 9 is formed of the same material as the coating portion 4 in this embodiment. As shown in FIG. 4, the seal portion 9 is formed to fill up the clearances between the strands 5A and between the strands 5A and the inner peripheral surface of the coating portion 4 in a water-tight state, whereby the passage of water beyond the seal portions 9 can be avoided. Further, rigidity is higher and bending strength is higher at positions where the seal portion 9 is formed than at positions where the seal portion 9 is not formed.

Next, a process of manufacturing the conductive wire L of this embodiment is described (see FIG. 5). First, the respective strands 5A of the conductive wire L are supplied from a plurality of rollers (not shown) provided in correspondence with the strands 5A (strand supplying step).

Each strand 5A supplied as described above is conveyed along an unillustrated conveyance path formed to extend to a twister 10 (twisting die). Further, a sealant supplying device 11 for supplying a sealant is arranged upstream of the twister 10. The sealant supplying device 11 includes a hopper 11A for storing the sealant (same material as the coating portion 4) in a molten state and supplies the sealant in the molten state to the respective strands 5A while the respective strands 5A are conveyed to the twister 10 (sealant supplying step). In this sealant supplying step, the sealant supplying device 11 drips an appropriate amount of the sealant to the respective strands 5A before the respective strands 5A are twisted by the twister 10. At this position, the respective strands 5A are in a state separated from each other immediately before being gathered. That is, since being dripped when the respective strands 5A are in such a loose state, the sealant is evenly attached to the entire peripheries of the strands 5A.

The respective strands 5A, to which the sealant was dripped in this way, immediately pass through the twister 10, where the strands 5A are twisted into the core 5 (twisting step). The respective strands 5A adhere to each other via the sealant attached thereto during this twisting. As a result, the sealant reliably spreads in the twisted core 5 and the clearances between the respective strands 5A in the twisted state are filled up.

The core 5 having passed through the twister 10 is introduced to a coating forming device 13 thereafter (the sealant is in an uncured state). The coating forming device 13 includes a hopper 13A for storing a coating material in a molten state and an extruder 13B communicating with this hopper 13A. The coating portion 4 is formed on the outer peripheral surface of the core 5 by the passage of the core 5 through this extruder 13B. In forming the coating portion 4, the coating portion 4 and the sealant are bonded without forming any boundary surface since the sealant is in the uncured state and the coating portion 4 is made of the same material as the sealant. That is, the sealant on the outer peripheral surface of the respective strands 5A and the inner peripheral surface of the coating portion 4 adhere and the clearances between the respective strands 5A and the inner peripheral surface of the coating portion 4 are filled up with the sealant or the coating portion 4. In this way, the conductive wire L with the seal function is obtained.

The conductive wire L formed in this way has the following effects.

Even if water adheres to the core 5 exposed at the position of the wire barrel 7 and infiltrates into the coating portion 4 by a capillary phenomenon with the ground terminal 1 connected to the ground point, water is stopped by the seal portion 9 and cannot pass through the seal portion 9. Thus, a situation where water penetrates into an electrical device connected to the ground terminal 1 can be reliably avoided.

Since the conductive wire L itself has a water stop function as described above, post-processes for water stoppage are not necessary after the laying of a ground wire unlike before. Thus, a ground wiring operation can be efficiently performed in a short time.

Further, since the coating portion 4 and the seal portions 9 are made of the same material in this embodiment, the both portions can be bonded without forming any boundary surface. Thus, the seal function can be further enhanced. Furthermore, since the sealant supplying step is set before the twisting step, the sealant can be evenly attached to the outer peripheral surfaces of the respective strands 5A. Thus, the clearances between the respective strands 5A including a central part of the core 5 can be satisfactorily filled up with the sealant.

Further, if the conductive wire L is formed with the seal portions 9, the rigidity of the conductive wire L is enhanced and bending strength is enhanced at the positions where the seal portions 9 are formed. Thus, the conductive wire L can be a wire difficult to buckle. Such a function is particularly effective if the conductive wire L is thin.

The present invention is not limited to the above described and illustrated embodiments. For example, the following embodiments are also included in the technical scope of the present invention.

Although the seal portion 9 is arranged behind the insulation barrel 8 in the above embodiment, it may be arranged immediately below the insulation barrel 8. By doing so, a compression amount of the entire conductive wire L associated with the caulking of the insulation barrel 8 can be reduced since the clearances between the respective strands 5A are eliminated by being filled up with the sealant. Thus, a caulking force of the insulation barrel 8 is not reduced and the strengthening of a caulked state can be expected.

Although the seal portions 9 and the coating portion 4 are formed of the same material in the above embodiment, they may be formed of different materials if they are held in close contact at interfaces.

Although the conductive wire L with the seal function is connected to the ground terminal 1 in the above embodiment, it may be applied to a terminal to be accommodated into a connector.

Although the sealant supplying step is set before the twisting step in the above embodiment, it may be set to be performed simultaneously with the twisting step.

Although the seal portions are arranged at the intermediate positions in the coating portion in the above embodiment, a seal portion may be formed over an entire length area in the coating portion.

### LIST OF REFERENCE NUMERALS

4 coating portion
5 core
9 seal portion
10 twister
11 sealant supplying device
13 coating forming device
L conductive wire

1. A conductive wire with a seal function, comprising:
a core formed of a plurality of conductive metal strands;
a coating portion formed of an insulating material and configured to cover the core; and
a seal portion arranged in the coating portion and configured to hold clearances between the strands and between the core and the coating portion in a water-tight state.

2. The conductive wire with the seal function of claim 1, wherein the seal portion and the coating portion are formed of the same material.

3. The conductive wire with the seal function of claim 2, wherein the seal portion is formed over an entire length range of the coating portion in the coating portion.

4. The conductive wire with the seal function of claim 1, wherein the seal portion is formed over an entire length range of the coating portion in the coating portion.

5. A method of manufacturing a conductive wire with a seal function, comprising:
a strand supplying step of supplying a plurality of conductive metal strands;
a twisting step of twisting the metal strands after the stand supplying step;
a sealant supplying step of attaching a sealant to the metal strands before or during the twisting step; and
a coating forming step of covering the twisted metal strands and the seal portion along a longitudinal direction with a coating portion.
